(19) United States
(12) Patent Application Publication
(10) Pub. No.: US 2009/0083622 A1
(43) Pub. Date: Mar. 26, 2009

(54) HANDWRITING RECORDING APPARATUS

(75) Inventors: Hung-Ming Chien, Taipei (TW); Chih-Chang Chou, Taipei (TW)

Correspondence Address: J C PATENTS, INC., 4 VENTURE, SUITE 250, IRVINE, CA, 92618, US

(73) Assignee: INVENTEC APPLIANCES CORP., Taipei (TW)

(21) Appl. No.: 12/166,131

(22) Filed: Jul. 1, 2008

(30) Foreign Application Priority Data
Sep. 26, 2007 (TW) 96135757

(51) Int. Cl. G06F 3/03

(52) U.S. Cl. 715/268

(57) ABSTRACT

A handwriting recording apparatus is provided. The handwriting recording apparatus includes a pen-shaped housing, a timer unit, a compass, a microprocessing unit, and a storage unit. The compass is equipped to the pen-shaped housing for detecting a moving direction of a motion of the pen-shaped housing. The timer unit is equipped inside the pen-shaped housing for recording a time data related to the motion of the pen-shaped housing. The microprocessing unit is equipped inside the pen-shaped housing for obtaining a motion vector of the pen-shaped housing according to the moving direction and the time data, and comparing the motion vector with a word data to generate a text file. The storage unit is equipped inside the pen-shaped housing for storing the text file so as to provide the text file for an external computer system to process or use.

### CROSS-REFERENCE TO RELATED APPLICATION

This application claims the priority benefit of Taiwan application serial no. 96135757, filed on Sep. 26, 2007. The entirety of the above-mentioned patent application is hereby incorporated by reference herein and made a part of this specification.

### BACKGROUND OF THE INVENTION

1. Field of the Invention

The present invention generally relates to handwriting recording apparatuses, and more particularly, to a handwriting recording apparatus for recording a text file.

2. Description of Related Art

In people's daily life, it often happens that there is something urgent and needed to be written down or make a memo. In such an occasion, pens and papers are more likely to be unavailable right away. Businessmen may be more familiar with such situations, because they more often need to record something or make a memo.

A most ordinary way of recording or making a memo is writing down on a paper with a pen. However, even though a pen has an acceptable portability, papers often occupies too much space and are not easy to take with, which brings inconvenience to the user. Fortunately, modern technologies are being rapidly developed, in which a portable electronic apparatus incorporating a MP3 player, a portable disk, and an audio recorder has been provided. The audio recorder is adapted for instantly recording voices, and encoding the voices into an audio file. The audio file is stored for subsequent processing.

However, although most of current PC equipments are compatible for processing text files, it is still not so convenient to process audio files generated by the foregoing portable electronic apparatus. For example, it is difficult to transmit an audio file of a memo instantly recorded at a roadside into Outlook of Microsoft® Office.

As such, it is a major concern to provide a handwriting recording apparatus for recording a text file to solve the above difficulty.

### SUMMARY OF THE INVENTION

Accordingly, the present invention is directed to a handwriting recording apparatus for recording a text file, so as to allow the user to instantly and conveniently record affairs or making a memo. The recorded text file is ready for subsequent processing by a processing system, for example, a personal computer. Further, the handwriting recording apparatus can be combined with a music player function, so as to provide more pleasure to the user. And in such a way, the user may be more likely to take it, so that the recording function thereof can be better presented.

The present invention provides a handwriting recording apparatus. The handwriting recording apparatus includes a pen-shaped housing, a timer unit, a compass, a microprocessing unit, and a storage unit. The compass is equipped to the pen-shaped housing for detecting a moving direction of a motion of the pen-shaped housing. The timer unit is equipped inside the pen-shaped housing for recording a time data related to the motion of the pen-shaped housing. The microprocessing unit is equipped inside the pen-shaped housing for obtaining a motion vector of the pen-shaped housing according to the moving direction provided by the compass and the time data recorded by the timer unit, and comparing the motion vector with a word data to generate a text file. The storage unit is equipped inside the pen-shaped housing for storing the text file generated by the microprocessing unit.

Further, the handwriting recording apparatus includes a music player module. The music player module is adapted to store at least one music file in the storage unit, and control the microprocessing unit to play the music file. With such a music player function, the handwriting recording apparatus would be more appreciated by the user and thus the user would be more likely to carry it.

In such a way, the handwriting recording apparatus for recording a text file is configured with a slim pen-shaped housing, together with a compass and a microprocessing unit equipped therein for cooperative identification, so as to allow the user to instantly and conveniently record affairs or make a memo. The recorded text file is ready for subsequent processing by a processing system, for example, a personal computer. Further, the handwriting recording apparatus can be combined with a music player function so as to provide more pleasure to the user. And in such a way, the user may be more likely to take it so that the recording function thereof can be better presented.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a view of a handwriting recording apparatus according to an embodiment of the present invention.

FIG. 2 is a schematic diagram illustrating the correlation between the components of the handwriting recording apparatus according to the embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

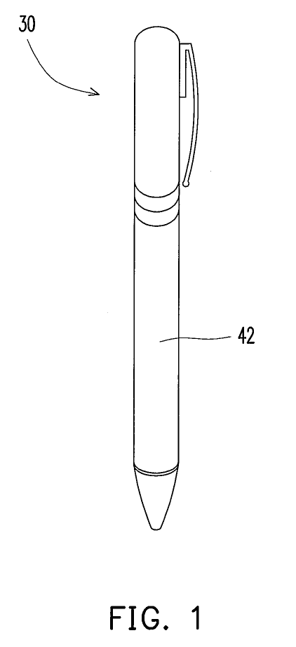

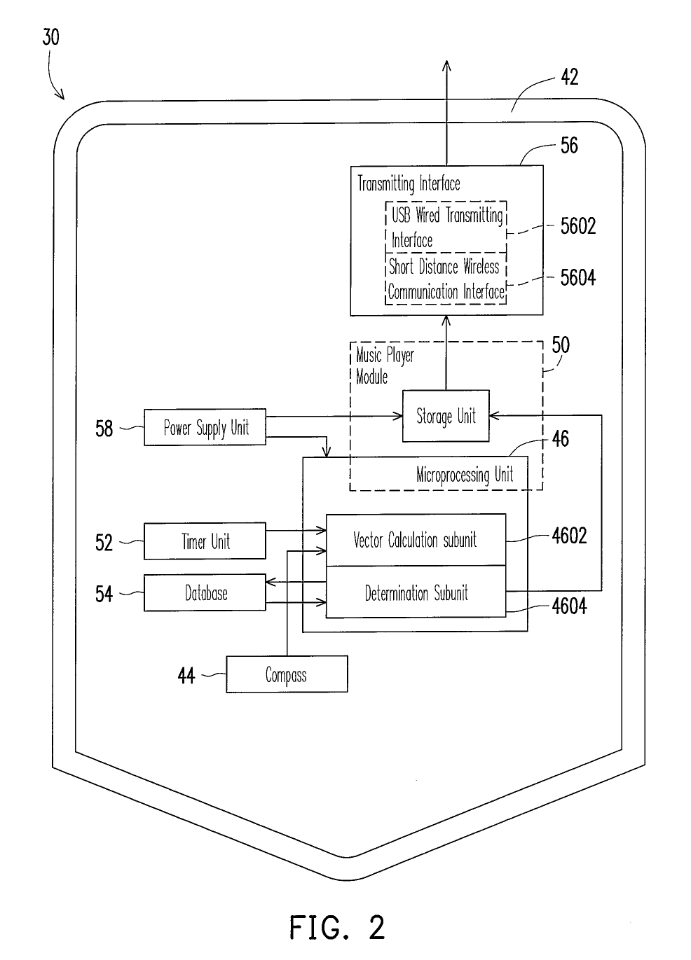

FIG. 1 is a view of a handwriting recording apparatus 30 according to an embodiment of the present invention. FIG. 2 is a schematic diagram illustrating the correlation between the components of the handwriting recording apparatus 30 according to the embodiment of the present invention. Referring to FIGS. 1 and 2, the handwriting recording apparatus 30 includes a pen-shaped housing 42, a compass 44, a timer unit 52, a microprocessing unit 46, and a storage unit 48.

The compass 44 is equipped to the pen-shaped housing 42 for detecting a moving direction of a motion of the pen-shaped housing 42. According to the embodiment, the compass 44 is preferably equipped at a writing head of pen-shaped housing 42. Because the writing head moves in accordance with the word being written, and the motion thereof is relatively apparent, it would be more definite in determining the direction of the motion of the pen-shaped housing 42 when the compass 44 is equipped at the writing head of the pen-shaped housing 42.

The timer unit 52 is equipped inside the pen-shaped housing 42 for generating a time data.

The microprocessing unit 46, for example, a microcontroller unit (MCU), is equipped inside the pen-shaped housing 42 for obtaining a text file by calculating and comparing according to the moving direction detected by the compass 44. The microprocessing unit 46 further includes a vector calculation subunit 4602, and a determination subunit 4604.

The vector calculation subunit 4602 is adapted for generating a length (distance) data according to a predetermined speed parameter and the time data generated by the timer unit 52. A motion vector can be obtained by combining the length data with the moving direction detected by the compass 44. The speed parameter can be, for example, an average moving speed of the writing head obtained by making an experiment. Typically, the average speed is within a range from about 4 centimeter per second to 45 centimeter per second. Further, a studying mode may be employed to obtain a more precise speed parameter corresponding to individual users respectively, in which speed parameters of different users are accumulated and provided for further calculation.

The determination subunit 4604 compares the motion vector generated by the vector calculation subunit 4602 with a word data pre-stored in a database 54, so as to generate a text data and store the text data with a text file corresponding to the text data. Further, the database 54 is adapted for pre-storing a large amount of word data therein, and accumulating a sum of a plurality of motion vectors of a block therein. For example, it is conventional to select a character having an approximate word shape from the database 54 according to a word comparison mode of a writing system of a typical personal digital assistant (PDA) having a touch control pad. Consequently, semantic comparison can be further introduced in addition for fast generating a series of text data having practical meaning, and generating the text file accordingly. The word comparison and the semantic comparison are well established technologies in the art, and are not to be further iterated hereby.

The storage unit 48 is equipped inside the pen-shaped housing 42 for storing the text file generated by the microprocessing unit 46. According to the embodiment of the present invention, the storage unit 48 is preferably a random access memory (RAM) or a flash memory.

Further, the handwriting recording apparatus 30 may include a music player module 50. When the storage unit 48 is a flash memory, the music player module 50 is adapted to store at least one music file (for example an MP3 format) in the storage unit 48, and control the microprocessing unit 46 to play the music file. Furthermore, the handwriting recording apparatus 30 may also be used as a portable disk for storing data. Since the handwriting recording apparatus is combined with more fun and more functions, it would be more appreciated by the user and thus the user would be more likely to carry it.

The handwriting recording apparatus 30 further includes a transmitting interface 56. The text file of the storage unit 48 can be transmitted out of the handwriting recording apparatus 30 to a processing system, for example, an external personal computer via the transmitting interface 56.

The transmitting interface 56, for example, can be a USB wired transmitting interface 5602, or a short distance wireless communication interface 5604. The USB wired transmitting interface 5602 is relatively cheap, and although expensive, the short distance wireless communication interface 5604 is more convenient for operation.

The handwriting recording apparatus 30 further includes a power supply unit 58, for example, AA or AAA alkaline batteries, or a lithium battery. The power supply unit 58 is provided for supplying power for the microprocessing unit 46, the compass 44, or any component therein requiring power for driving.

In such a way, the handwriting recording apparatus 30 for recording a text file is configured with a slim pen-shaped housing 42, together with a compass 44 and a microprocessing unit 46 equipped therein for cooperative identification, so as to allow the user to instantly and conveniently record affairs or make a memo. The recorded text file is ready for subsequent processing by a processing system, for example, personal computer. Further, the handwriting recording apparatus 30 can be combined with a music player function, so as to provide more pleasure to the user. And in such a way, the user may be more likely to take it, so that the recording function thereof can be better presented.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A handwriting recording apparatus, comprising:
a pen-shaped housing;
a compass, equipped to the pen-shaped housing, capable of detecting a moving direction of a motion of the pen-shaped housing;
a timer unit, equipped inside the pen-shaped housing, capable of recording a time data related to the motion of the pen-shaped housing;
a microprocessing unit, equipped inside the pen-shaped housing, capable of obtaining a motion vector of the pen-shaped housing according to the moving direction detected by the compass and the time data recorded by the timer unit, and comparing the motion vector with a word data to generate a text file; and
a storage unit, equipped inside the pen-shaped housing, capable of storing the text file generated by the microprocessing unit.

2. The handwriting recording apparatus according to claim 1, further comprising:
a vector calculation subunit, capable of calculating a moving distance according to a predetermined speed parameter and the time data generated by the timer unit, and obtaining the motion vector by combining the moving distance with the moving direction detected by the compass; and
a determination subunit, capable of comparing the motion vector generated by the vector calculation subunit with a word data pre-stored in a database, so as to generate a text data and store the text data with a text file corresponding to the text data.

3. The handwriting recording apparatus according to claim 1, further comprising:
a transmitting interface, capable of transmitting the text file stored in the storage unit to an external processing system which is out of the handwriting recording apparatus.

4. The handwriting recording apparatus according to claim 3, wherein the transmitting interface is a USB wired transmitting interface.

5. The handwriting recording apparatus according to claim 3, wherein the transmitting interface is a short distance wireless communication interface.

6. The handwriting recording apparatus according to claim 1, further comprising:
a power supply unit, capable of supplying power to the microprocessing unit and the compass.

7. The handwriting recording apparatus according to claim 1, further comprising:
a music player module, capable of storing at least one music file in the storage unit, and control the microprocessing unit to play the music file.
